(19) United States
(12) Patent Application Publication
(10) Pub. No.: US 2020/0376417 A1
(43) Pub. Date: Dec. 3, 2020

(54) FILTER APPARATUS AND/OR METHOD

(71) Applicants: Oded SHAMIR, Gedera (IL); Yuval SHAMIR, Kibbutz Hagoshrim (IL)

(72) Inventors: Oded SHAMIR, Gedera (IL); Yuval SHAMIR, Kibbutz Hagoshrim (IL)

(21) Appl. No.: 16/761,835

(22) PCT Filed: Nov. 18, 2018
(86) PCT No.: PCT/IB18/59083

§ 371 Date: May 6, 2020

Related U.S. Application Data
(60) Provisional application No. 62/588,363, filed on Nov. 19, 2017.

(51) Int. Cl. B01D 29/64; B01D 29/03; B01D 29/39

(52) U.S. Cl. CPC B01D 29/6453; B01D 29/03; B01D 2201/082; B01D 2201/583; B01D 29/39

(57) ABSTRACT

A filter apparatus is used for at least partially removing dirt from a pressurized liquid flow passing therethrough. The filter apparatus includes a harvesting utility for harvesting electrical energy from the liquid flow, and at least part of the harvested electrical energy can be used for powering a cleaning mechanism of the apparatus that periodically cleans the filter apparatus.

### TECHNICAL FIELD

Embodiments of the invention relate to a filter system and in particular a self-cleaning fluid filter system.

### BACKGROUND

Filter systems, such as screen-type filters, disc type filters, fiber type filtration systems, microfiber filtration systems (and the like)—normally include cleaning utilities for performing a back-washing cleaning action of particles that may accumulate on filtration medias of such filters. The cleaning utilities normally utilize pressurized fluid jets and/or suction for removing these particles.

Forming such pressure useful for cleaning requires energy, such as electrical energy, which may be scarce or limited in certain regions or applications where filtration is required. Therefore, filtration systems may be designed to utilize hydraulic energy in the form of relative high incoming fluid pressures, which are fed into the systems.

U.S. Pat. No. 7,055,699 for example describes a self-cleaning mechanical filter that includes a mechanism for simultaneously cleaning the internal surface and the external surface of a filter element. The filter performs pressurized suction scanning of solid materials accumulated on the internal surface of the filter element; and can be operated in synchronization with the suction scanning structure for backwashing the external surface of the filter element during a self-cleaning process.

Such cleaning cycles of filters may also be propelled by hydraulic power, by utilizing fluid flow/pressure as propulsion fluid for urging motion (such as axial and/or rotational) of suctions nozzles used for removing solid materials accumulated on internal surfaces of filter elements. U.S. Pat. No. 9,347,570 may be one example of a filter utilizing such a fluid driven force in its cleaning process.

### SUMMARY

The following embodiments and aspects thereof are described and illustrated in conjunction with systems, tools and methods which are meant to be exemplary and illustrative, not limiting in scope.

An aspect of the present invention, applicable to at least certain embodiments of the present invention, may be defined as relating to a filter apparatus/utility comprising an energy harvesting utility—that may be suited for harvesting “excess” pressure(s) existing within a liquid system in liquid communication therewith.

Possibly, such harvesting apparatus/utility may be arranged to harvest electrical energy to be used for at least partially powering a cleaning action of the filtering utility.

Such harvesting of “excess” pressure(s) may be defined as following. If e.g. a liquid system in communication with the filtering utility may typically require a certain ‘given pressure’ for its operation, while in said liquid system more than the ‘given pressure’ may be available constantly or periodically—such “excess” pressure(s) may be harvested for storage e.g. in a battery for later use in order to power a cleaning action in the filter utility.

In a broad aspect of the present invention, harvesting of hydraulic energy and possible storage of such harvested energy e.g. in a battery for later use—may be implemented or utilized in or on a wide variety of filtering devices—such as screen-type filters, disc type filters, fiber type filtration systems, microfiber filtration systems (and the like). Such harvested energy may be utilized for powering a variety of apparatuses within a filter utility, such as a motor for actuating a cleaning action (or the like).

An aspect of the present invention may be defined as providing filtration apparatus embodiments capable of performing cleaning procedures of particles accumulating therein during filtration, while requiring low energy inputs.

In an embodiment there may be provided a filter apparatus for at least partially removing dirt from an incoming fluid flow that is then communicated onwards downstream in a cleaner form, the apparatus comprising a harvesting utility for harvesting electrical energy from fluid flowing therethrough, wherein the harvesting utility being configured to also supply energy for operation of the apparatus.

Possibly, a controller may be provided for controlling operation of the utility, for example for controlling if the utility is used for harvesting and/or for supplying energy.

In at least certain embodiments, the filter apparatus may be arranged to include a battery for storing energy harvested by the utility and/or for supplying energy for operation of the utility.

Possibly, the filter apparatus may comprise a cleaning means for urging dirt removed from the fluid flowing through the apparatus out of the apparatus, wherein the cleaning means mat utilize a pressure drop between pressurized fluid within the apparatus and the ambient environment for sucking out of the apparatus dirt removed from the fluid flowing through the apparatus.

Possibly, at least a portion of the cleaning means being urged to move in order to urge removal of dirt from several locations in the apparatus, wherein movement of the at least portion of the cleaning means is urged by hydraulic energy arriving from fluid flowing through the apparatus and/or by electrical energy arriving from the utility.

In at least certain embodiments, such low energy consumption may be facilitated at least in part by a hybrid mode of operation, including harvesting of energy form incoming pressurized hydraulic fluid that may be stored for later use in cleaning procedures.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows an embodiment of a harvesting utility within a filter apparatus/utility embodiment of the present invention;

FIG. 2 schematically shows another embodiment of a harvesting utility within a filter apparatus/utility embodiment of the present invention; and

FIG. 3 schematically shows yet a further embodiment of a harvesting utility within a filter apparatus/utility embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

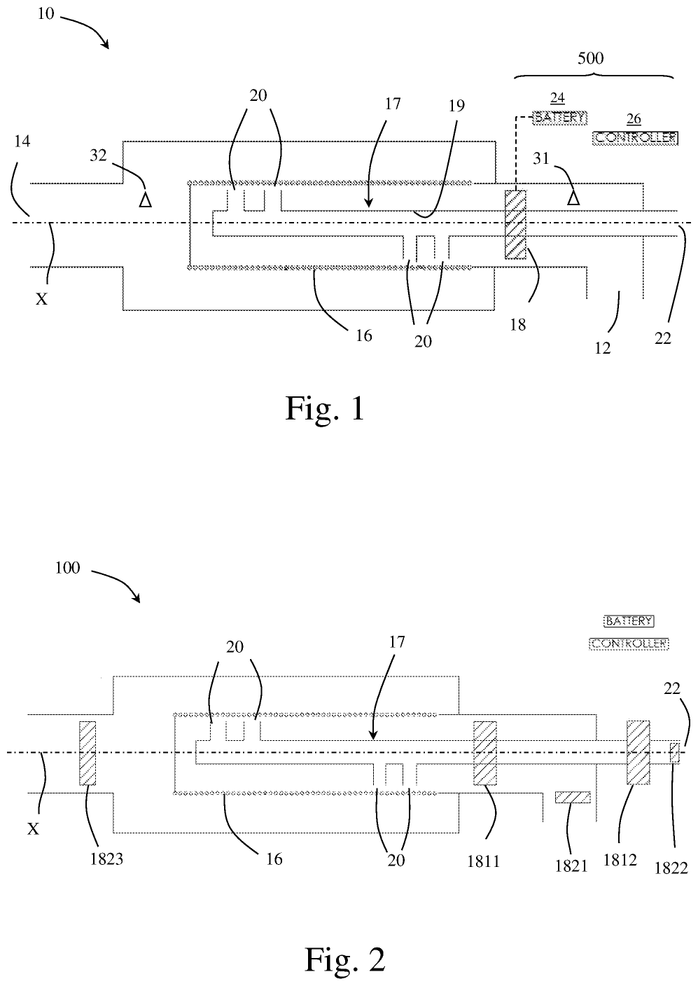

Attention is first drawn to FIG. 1 illustrating a first embodiment of a filter apparatus/utility 10 of the present invention. Apparatus 10 may have an inlet 12, an outlet 14 and a filter media 16, here in an optional form of a so-called screen, located in-between the inlet and outlet and formed about an axis X of the apparatus. Fluid entering the filter via inlet 12 may be arranged to flow passed the filter media where particles may be removed from the fluid, which may then be arranged to flow onwards downstream via outlet 14 for further possible use e.g. in a liquid system downstream.

In an aspect of the present invention, fluid flowing downstream out of outlet 14 may be configured to be used for irrigation purposes, for example in a drip irrigation type liquid system that may require incoming fluid pressure of e.g. about 10-40 meters of water or about 1-4 bar.

Further examples of use may be in Industrial water filtration systems where embodiments of the present invention may assist in saving energy—by providing harvested electrical energy that may be utilized in self-cleaning processes of such water filtration system e.g. in an industrial environment.

Yet further examples of use of filter utility embodiments of the present invention may be envisioned is a municipal or residential environment—where e.g. tap water may undergo filtration prior to use in a building, a neighborhood, a larger city area (or the like).

Filters may be located far from electrical power sources and thus provision of electrical harvesting capabilities for powering utilities within such filters—such as cleaning capabilities may permit provision of filtration in larger scales or finer filtration.

Fine filtration requiring relative higher energy may be found also in the agricultural domain where e.g. organisms (such as nematode) that may pose a threat to certain crops may require relative fine filtration processes e.g. about 5-20 micron filtration. Thus, electrical energy harvested from hydraulic power in such filtration systems may be highly beneficial.

A further example may be in intensive agriculture (e.g. greenhouses, high pressure irrigation, industrial agriculture etc.)—where liquid flow may be provided at relative high pressures (e.g. about 50-80 meters of water or about 5-8 bar)—thus making harvesting of electrical energy in such systems especially suitable and efficient.

The filtering apparatus/utility may be arranged to include an internal hub 17 located along axis X and within filter media 16. Hub 17 may be arranged to include suction nozzles 20 for removing dirt particles here from an interior face of filter media 16 and an internal lumen 19 for communicating such dirt out of the apparatus to the ambient environment via an exit 22.

Embodiments of filter apparatuses/utilities of the present disclosure (e.g. 10 or later described 100 or 1000)—may include a harvesting utility (for utility 10 see exemplary elements thereof being marked by numeral 500), which may be comprised or formed of (as e.g. seen in the example of FIG. 1) an electric utility 18 located downstream from a filter's inlet (e.g. 12) and possibly upstream from the filter's media (e.g. 16), here coupled on an outer side of a section of the hub. In some embodiments, such an electric utility as 18 in FIG. 1 (or see alternative/additional example 1811 in FIG. 2)—may be in the form of a generator or alternator for harvesting energy from pressurized fluid entering the apparatus via inlet (e.g. 12). Such fluid flowing passed and/or through the utility may be urged to cause rotation within the utility that in turn produces electrical energy that can be harvested, and possibly stored in a battery (e.g. 24) of the apparatus.

Energy stored in the battery in certain cases may be used for supplying energy to external devices, such as valves, pumps, sensors, control units, fertilizers (or the like). The battery in some cases may also be coupled to external sources, such as an electrical grid or external power source, for receiving energy.

In at least certain embodiments, electric utility 18, 1811 may be controlled to be used during at least certain periods of time as an electrical motor, hence imparting to electric utility 18 a possible dual functionality. A controller 26 may be used for determining operation of the electric utility, such as triggering utility into an operational mode as a motor.

Electric utility 18 in some embodiments may be used for urging hub 17 to rotate about axis X and/or advance along axis X, possible back and/or forth along axis X. Such back and forth movement along axis X may be assisted e.g. by a gear embedded and/or in cooperation with at least portions of the utility (or by any other suitable means). Such movements of hub 17 may be performed during a cleaning action when suction is urged via nozzles 20 in order to remove dirt from filter media 16 out of the apparatus via exit 22.

In certain cases—embodiments of an electric utility (e.g. 18, 1811) while utilized in ‘motor’ mode for electrically powering movement(s) of e.g. a filter's cleaning mechanism—may be assisted in the urging of such electrically powered movements by hydraulic power in form of pressurized liquid flow that may be arranged to continue to flow passed and/or through the utility to also hydraulically power such movements.

For example, at least certain utility embodiments may be arranged to “harvest” electrical energy when in ‘alternator/generator’ mode by e.g. rotation that may be urged within the utility about an axis of the utility in a given rotational direction R_{G}—due to liquid flowing passed and/or through the utility. Same embodiments—in turn when altered into ‘motor’ mode may be arranged to commence outputting electrical power possibly in the form of torque about same axis and in the same given rotational direction R_{G}.

By diverting liquid to continue to flow passed and/or through the utility when in ‘motor’ mode and by that assist the urging of rotation about the utility's axis in direction R_{G} by hydraulic power—additional power to that provided by the stored electrical power may be outputted.

Such an arrangement—may be useful in various cases—such as when available “harvested” electrical power may be relatively low for suitably powering required movements e.g. of a filter's cleaning mechanism alone—and thus by “harnessing” available hydraulic power present in the system—larger magnitudes of power may be utilized for producing a required “work” (e.g. moving elements of a filter's cleaning mechanism).

In certain cases, energy stored in the battery may be used for urging the suction via the nozzles 20. In certain cases, embodiments of filtering apparatus/utility 10 may include pressure sensors 31, 32 located upstream and downstream of filter media in order to measure a pressure drop over the filter media. Such pressure drop may be fed to the controller as incoming information in order to asses—instances where the filter media becomes clogged with dirt particles and hence less efficient.

In an aspect of the invention, the controller may be configured to operate electric utility 18 for harvesting energy when pressure difference between measurements by sensors upstream and downstream of the filter media, such as sensors 31 and 32, may be below a certain pressure threshold. And, once the pressure difference rises above the threshold, indicating possible clogging or start of clogging of the media; the controller may urge the electric utility into a motor mode of operation together with start of suction via the nozzles in order to commence a cleaning sequence of the filter media.

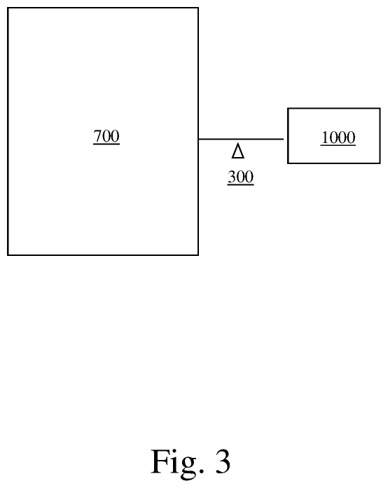

In a further aspect, possibly combinable with the former discussed aspect(s)—an embodiment of a filtering apparatus/utility may be arranged to harvest “excess” pressures detected as existing within a liquid system to which said filtering utility may be coupled in fluid communication. With attention additionally drawn to FIG. 3 a very schematic example of the aforementioned may be examined.

FIG. 3 illustrates a filtering utility/apparatus 1000 arranged in liquid communication with a liquid system 700 downstream—for example an irrigation liquid system (or the like). The filtering utility or a controller (not shown) controlling operation of filtering utility 1000 may be arranged to receive sensed data e.g. from a sensor 300 in liquid communication with liquid system 700. Filtering utility 1000 may include a “harvesting” utility for converting hydraulic energy (e.g. flow, pressure etc.) to electrical energy—and may come in various forms, such as those in the embodiments discussed with regards to FIGS. 1 and 2.

The liquid system may be determined e.g. according to its design and/or intended use—to require a certain given incoming liquid pressure for its proper operation—and sensed pressure data arriving from sensor 300 may be used to detect existence of a liquid pressure at or within liquid system in “excess” of the required pressure for its operation.

For example, a predefined pressure level PL possibly defining a pressure level required for optimal operation of liquid system 700 may be provided—and filtering utility 1000 and/or a controller of or associated with the utility—may determine if a pressure PS measured by a sensor such as at the location of sensor 300—exceeds predefined pressure level PL (i.e. is PS>PL).

If existence of such “excess” pressure may be identified—this may result in the entering into a “harvesting” cycle at the filtering utility 1000. A drop in the detected pressure PS to below PL—may ignite terminating of such “harvesting”. It is noted that sensor 300 may be located at other locations within the systems—such as at a location within liquid system 300 or even adjacent its downstream side.

Detection of such “excess” pressure within liquid system 700 may accordingly be utilized for commencing a “harvesting” action within the filter utility/apparatus 1000 in order to possibly store such harvested electrical energy for later use in a cleaning action possibly performed in the filter utility, such as cleaning actions described in connection to FIGS. 1 and 2. Liquid arriving from upstream to liquid system may initially flow via filtering utility/apparatus 1000 and from there flow further downstream towards the liquid system via sensor 300.

With attention drawn back to FIG. 1 it is noted that filter apparatus/utility 10 in at least certain embodiments may be provided with a controller for controlling operation of electric utility 18. For instance, the controller may determine periods during which the electric utility may be used to a lower extent for harvesting energy, e.g. possibly not used at all, and hence causing less interference with fluid flowing passed it and consequently less pressure loss. Such lower usage of the electric utility may occur e.g. during periods when no further harvesting of energy is required, for example due to the battery being full.

In at least certain embodiments of the present invention, during a self-cleaning phase of a filter media such as filter media 16, a suction process of debris by the nozzles 20 may be urged by ‘hydraulic energy’ in form a pressure gap (difference) existing between fluid pressure present at a vicinity of the suction nozzles adjacent filter media 16 and ambient atmospheric pressure present at exit 22. Such ‘hydraulic energy’ may be arranged to urge dirt to be sucked away from the filter media 16 to outside of the apparatus via exit 22, so that efficient filtering of the apparatus may be resumed.

In order to remove dirt from substantially the entire inner face of filter media, the suction nozzles may be urged to move, e.g. back and/or forth along axis X of the filter apparatus and possibly also simultaneously about the axis.

In some cases, such movement of the suction nozzles about and/or along axis X may be urged by electric utility embodiments, such as electric utility 18 (and later discussed electric utilities 1811-1823), which on the one hand accordingly serve for harvesting electrical energy and when required may be used for electrically activating the movements required for performing a scanning cleaning process of the filter's media 16.

In some cases, (not illustrated) filter embodiments (such as 10 and later discussed 100) may be configured for utilizing ‘hydraulic power’ for performing movement of the suction nozzles for instance along and/or about the filter's axis X, such as e.g. described in the filtering unit of U.S. Pat. No. 9,347,570.

In some cases, electrical utility embodiments may include turbine blades possibly utilized to be rotated by the fluid stream flowing therethrough in order to add more ‘hydraulic powered’ spinning energy to along and/or about X axis in parallel to the action of for example an electrical motor.

In certain filter embodiments, energy losses, e.g. due to friction between suction nozzles (e.g. 20) and a filter media (e.g. 16), motor and gear parts, bearings, pistons (and the like) may be compensated by energy arriving from at least certain electrical utility embodiments (e.g. 18, and later discussed 1811-1823), where electric power possibly form of an electric motor may be configured (e.g. via a controller) to kick into operation.

Electrical energy from electrical utilities may be configured to contribute ‘electrically activated power’ to such ‘hydraulic powered’ scanning process according to various criteria (i.e. not necessarily due to the aforementioned energy loss criteria) and by that provide so-called “hybrid” powered filter embodiments combining ‘hydraulic activated powers’ and ‘electrical activated powers’ powers e.g. in their cleaning processes.

In certain embodiments, where ‘electrical power/energy’ from a utility (e.g. 18, and later discussed 1811-1823) may be used in conjunction with ‘hydraulic power’, energy optimization may be provided between such ‘hybrid’ power sources (‘hydraulic’ and ‘electrical’) by configuring the suction cleaning process of debris to rely substantially mainly on ‘hydraulic energy’ (e.g. the pressure ‘gap’ substantially alone), while ‘electric powered energy’ arriving from an electrical utility may be used to assist in urging required movements of such nozzles (e.g. along and/or about axis X). Such optimization may be controlled by a central controller included in certain embodiments of a system and/or apparatus of the invention.

Attention is drawn to FIG. 2 illustrating an embodiment of a filter apparatus/utility 100. Filter apparatus 100 possibly includes generally similar elements bearing same numerals as in the previously discusses apparatus, such as hub 17, suction nozzles 20 (and the like). Filter apparatus 100 however mainly exemplifies that its electrical, mechanical and hydraulic utility may be divided according to functionality, here to include dedicated motors/pistons 1811 and 1812 located on hub 17 in order to urge movement to the suction nozzles. For example, one of these utilities may be used for urging rotation of the hub about axis X while the other translation along the axis X, possibly back and forth.

The electrical utility embodiment of apparatus 100 may here be shown to include dedicated generators 1821, 1822, 1823 for harvesting energy; possibly located at various locations in the filtering apparatus. For example, at the inlet of the filtering apparatus, and/or at its outlet and/or possibly at the dirt outlet.

That is to say that the embodiment of filter apparatus/utility 100 exemplifies an option where a system, such as that shown in FIG. 1, may be separated into few components that may differ each from other by location and/or action. The location and action of the different components (such as the motors/pistons 1811 and 1812 and generators 1821, 1822 and 1823 etc.) are shown here as an example only.

Generators 1821, 1822 and 1823 in a non-binding example may be Micro-energy harvesting systems e.g. installable in liquid pipelines and capable of providing up to about 10, 20 (and more) Watt of available power.

In an aspect of the present invention, at least certain electric utility embodiments may be arranged to be introduced to existing filter apparatuses/utilities to ‘so-called’ retrofit such filters to include electrical “harvesting” and electrical/hydraulic “powering” abilities. That is to say that a filter apparatus, which prior to such retrofitting may be arranged to be powered e.g. solely by external electrical power and/or by hydraulic power—may by retrofitted with such discussed electric utility embodiments—to also be powered at least partially by electrical/hydraulic energy harvested in such retrofitted system. An example of an electrical utility embodiment that may be introduced to an existing filter apparatus—may be that e.g. marked by numeral 500 in FIG. 1 or those shown and discussed with reference to FIG. 2.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A filter apparatus for at least partially removing dirt from a pressurized liquid flow passing therethrough, the filter apparatus comprising a harvesting utility for harvesting electrical energy from the liquid flow, wherein at least part of the harvested electrical energy is used for at least partially powering a cleaning mechanism of the apparatus that at least periodically applies a cleaning action to the filter apparatus.

2. The filter apparatus of claim 1 and comprising a filter media for filtering dirt away from the liquid flow, and the cleaning action is applied to the filter media.

3. The filter apparatus of claim 2, wherein the cleaning mechanism comprises at least one suction nozzle for applying suction against the filter media for sucking dirt away from the filter media.

4. The filter apparatus of claim 3, wherein a downstream end of the suction nozzle is in communication with the ambient environment and suction is applied due to pressure drop between pressure of the pressurized liquid flow existing adjacent the filter media and a lower pressure at the ambient environment.

5. The filter apparatus of claim 3, wherein the cleaning action comprises urging the suction nozzle to move to apply suction against different regions of the filter media.

6. The filter apparatus of claim 4, wherein movement of the suction nozzle is powered at least partially by energy harvested by the harvesting utility.

7. The filter apparatus of claim 6, wherein movement of the suction nozzle is powered by at least one electrical utility.

8. The filter apparatus of claim 2 and comprising harvesting and cleaning cycles and the electrical utility acts as an alternator during a harvesting cycle and as an electrical motor during a cleaning cycle, where preferably harvesting cycles occur when a pressure drop over the filter media is lower than a pre-defined limit and cleaning cycle occur when the pressure drop is higher that the given pre-defined limit.

9. The filter apparatus of claim 8, wherein while acting as a motor the electrical utility is arranged to be powered also by liquid flowing passed and/or through the utility.

10. The filter apparatus of claim 9, wherein the filter apparatus is a screen filter with the filter media being a screen.

11. The filter apparatus of claim 9, wherein the filter apparatus is a disc filter with the filter media being one or more discs.

12. The filter apparatus of claim 9, wherein the filter apparatus is a fiber filtration systems or microfiber filtration system with the media being fibers or microfiber, respectively.

13.-21. (canceled)

22. A filter apparatus for at least partially removing dirt from a pressurized liquid flow passing therethrough, the filter apparatus comprising a harvesting utility for harvesting electrical energy from the liquid flow, wherein at least part of the harvested electrical energy is used for at least partially powering a cleaning mechanism of the apparatus that at least periodically applies a cleaning action to the filter apparatus.

23. The filter apparatus of claim 22 and comprising a battery for storing at least part of the electrical energy harvested by the harvesting utility.

24. The filter apparatus of claim 23 and comprising a media for filtering dirt away from the liquid flow and pressure sensors upstream and downstream of the media, wherein activation of a cleaning action is when pressure difference between upstream and downstream of the media exceeds a pre-defined limit.

25. The filter apparatus of claim 24, wherein activation of a harvesting action is when pressure difference between upstream and downstream of the media is below a pre-defined limit.

26.-39. (canceled)
